(19) United States
(12) Patent Application Publication
(10) Pub. No.: US 2010/0122493 A1
(43) Pub. Date: May 20, 2010

(54) APPARATUS FOR SASH WINDOW

(75) Inventor: Kevin John Burrows, Middlesex (GB)

Correspondence Address: LAUBSCHER & LAUBSCHER, P.C., 1160 SPA ROAD, SUITE 2B, ANNAPOLIS, MD, 21403, US

(73) Assignee: SASHMATIC LIMITED, Chorley (GB)

(21) Appl. No.: 12/613,785

(22) Filed: Nov. 6, 2009

(30) Foreign Application Priority Data
Nov. 14, 2008 (GB) 0820848.0

(51) Int. Cl. E05F 11/48; B23P 17/00

(52) U.S. Cl. 49/358; 29/897.3

(57) ABSTRACT

Apparatus for raising and lowering a sash (14) relative to the frame of a sash window. The apparatus comprises at least one first pulley (34) for fixed attachment to the sash, at least one second pulley (36) for moveable engagement with the sash, a cord (44) which passes around and away from the first and second pulleys for attachment to a fixed point on the window frame (18), for operably linking the position of the sash relative to the window frame to the position of the second pulley(s) relative to the sash, and driving means (58) for moving the second pulley(s) relative to the sash, to thereby raise and lower the sash relative to the window frame.

The present invention relates to apparatus for raising and lowering a sash of a sash window (double-hung window).

Block and tackle balances for use with sash windows are known. Such balances use a system comprising a tension spring and two or more pulleys with a cable or cord threaded between them, and serve to assist a user when opening and closing the window by counterbalancing the weight of each sash. As a result, the force that needs to be exerted by the user to raise the sash is reduced.

However, in certain circumstances, it is desirable to enable a user to open a window at the touch of a button. This is particularly desirable for elderly or disabled users, or in cases where it is necessary to regularly open and close large numbers of windows, such as in school buildings.

This may be achieved by providing a motor to drive the sash up and down, so that no effort on the part of the user is required. For example, WO-A-03/012237 discloses a rack and pinion drive used to open and close sash windows.

However, the weight of a typical sash window means that the motor and associated drive mechanism required for this purpose are bulky, expensive, and consume a considerable amount of power during operation.

Moreover, in many instances, the window frame is not large enough to house the motor and associated mechanism, resulting in an ungainly housing being required in proximity to the window.

It is an object of the present invention to overcome the above problems.

According to a first aspect of the present invention there is provided apparatus for raising and lowering a sash relative to the frame of a sash window, the apparatus comprising:—

at least one first pulley for fixed attachment to the sash;

at least one second pulley for moveable engagement with the sash;

a cord which passes around and away from the first and second pulleys for attachment to a fixed point on the window frame, for operably linking the position of the sash relative to the window frame to the position of the second pulley(s) relative to the sash; and

driving means for moving the second pulley(s) relative to the sash, to thereby raise and lower the sash relative to the window frame.

Since movement of the sash is driven by the driving means, no effort is required of the user other than, for example, pressing a button to control the driving means to raise or lower the sash. Moreover, since the driving means drives a component which is moveably associated with the sash, rather than the sash itself, the driving means may be entirely housed within the frame of the sash. Consequently, the driving means may be hidden from view, resulting in a neat visual appearance of the window. In particular, the driving means can be accommodated within the dimensions of a recess or cavity formed in a standard sash window to house a block and tackle balance mechanism. Accordingly, the present invention can be readily incorporated within the standard design of such windows, with minimal changes to the manufacturing processes, and minimal (if any) changes to the visual appearance of the window. Furthermore, desirable features such as a sash tilt facility often provided with standard block and tackle balance sash windows are not affected by the provision of the powered system of the present invention, and can thus be retained.

In a preferred embodiment, the apparatus further comprises spring means for exerting an upward force on the second pulley, to counterbalance at least a share of the weight of the sash.

In cases where the spring means is required to counterbalance the full weight of the sash, the spring means may be required to exert a force which is substantially equal to the full weight of the sash. However, in many cases, the apparatus of the invention will be used in combination with at least one additional balance mechanism, which may comprise additional spring means. In such cases, the spring means may be configured to exert a force substantially equal to a predefined share of the weight of the sash (generally half the weight of the sash) on the second pulley, such that the spring means counterbalances the full weight of the sash in combination with such additional balance mechanism(s).

The spring means may comprise a tension spring, which may be attached at one end to the sash and at the other end to the second pulley.

By providing means for counterbalancing the weight of the sash, the power required for raising and lowering the sash is reduced, since the only work required of the driving means is that required to overcome friction in the system. Thus, the driving means is not required to bear the weight of the sash. Moreover, the size of the motor required is significantly reduced, compared with the size of motor required by previous known devices, such as the rack and pinion drive system of WO-A-03/012237. The present inventors have found that by counterbalancing the weight of the sash in this way, the sash can be raised and lowered by a commercially available motor which is small enough to fit within the recess formed in the frame of a standard block and tackle balance sash window.

Moreover, because the motor is smaller than that of known motorised sash windows, it is cheaper to install and run, and is more energy efficient.

The apparatus of the present invention may comprise a single first pulley and a single second pulley. Alternatively, the apparatus may comprise additional first and or second pulleys. The number of first and second pulleys required depends on the ratio that is required between the movement of the second pulley and the movement of the sash.

The second pulley may be configured to be linearly moveable relative to the sash, whilst rotational movement of the second pulley relative to the sash is substantially prevented.

The driving means preferably comprises a driving member for attachment to the second pulley, and a rotational member for engagement with the driving member, such that rotation of the rotational member causes the driving member to move linearly for moving the second pulley relative to the sash.

The rotational member preferably has a threaded surface for engaging a correspondingly threaded surface associated with the driving member for linearly moving the driving member when the rotational member is rotated. The threaded surface may be arranged as a single or multi-start thread. The rotational member may be rotated by a motor. The driving member may be an elongate tube. The rotational member may be an elongate cylinder.

The driving member, the second pulley and the sash itself are each preferably movable in a substantially vertical direction. It should be noted that in some cases, a sash window may be provided at an angle to the vertical. Alternatively, a sash may be configured to tilt within the window frame, such that the sash and the mechanism contained therein may be orientated at an angle to the vertical. Accordingly, for the purpose of the present specification, the term “vertical” or “substantially vertical” should be taken to encompass such directions provided they have a vertical component.

The driving member and/or the rotational member are preferably coaxial with the spring means. In the case where the spring means comprises a coil spring, the driving member and/or the rotational member are preferably located radially within the turns of the spring.

With this configuration, the driving member and the rotational member occupy space within the frame of a sash window that is not utilised in standard block and tackle balance sash windows, such that the frame of the sash and/or the recess formed therein do not need to be redesigned to accommodate these components.

The apparatus of the present invention may further comprise control means for controlling operation of the driving means.

The apparatus of the present invention may further comprise means for detecting the position of the sash relative to the window frame.

The apparatus of the present invention may further comprise means for detecting when movement of the sash is obstructed.

According to a second aspect of the present invention, there is provided a sash window which incorporates one or more apparatuses as defined in the claims.

A sash of the sash window may comprise one or more apparatuses as defined in the claims in combination with one or more unpowered balance mechanisms for counterbalancing the weight of the sash. In particular, such a sash may comprise a powered mechanism at one side, and an unpowered balance mechanism at the other side.

According to a third aspect of the present invention there is provided a method of fitting the apparatus of the present invention to a sash window fitted with a block and tackle balance mechanism, the method comprising:—

removing the spring of the block and tackle balance mechanism;

mounting a motor within the space previously occupied by said spring;

connecting a rotational member to the motor;

engaging a driving member with the rotational member;

engaging the driving member with a movable pulley of the block and tackle mechanism.

The method may further comprise selecting a new spring, attaching the new spring at one end to the sash at an attachment point below the motor within the recess, and at the other end to an attachment point on the moveable block.

The above steps need not necessarily be performed in the order they are recited in the claim.

The term “block and tackle balance” as referred to herein means a balance which uses a spring in conjunction with a block and tackle mechanism (i.e., a system of two or more pulleys or “blocks” with a cable or cord threaded between them) for counterbalancing a load.

The term “cord” as referred to herein encompasses, for example, any cord, string, rope, wire or cable means for acting in cooperation with the pulleys.

An embodiment of the present invention will now be described with reference to the accompanying diagrams in which:—

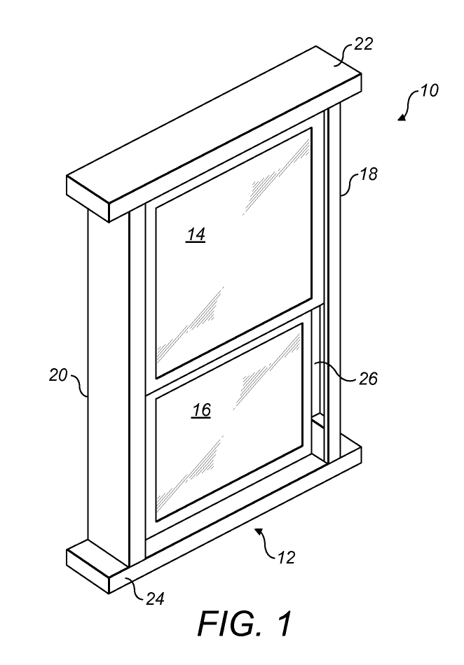

FIG. 1 is a perspective illustration of a sash window;

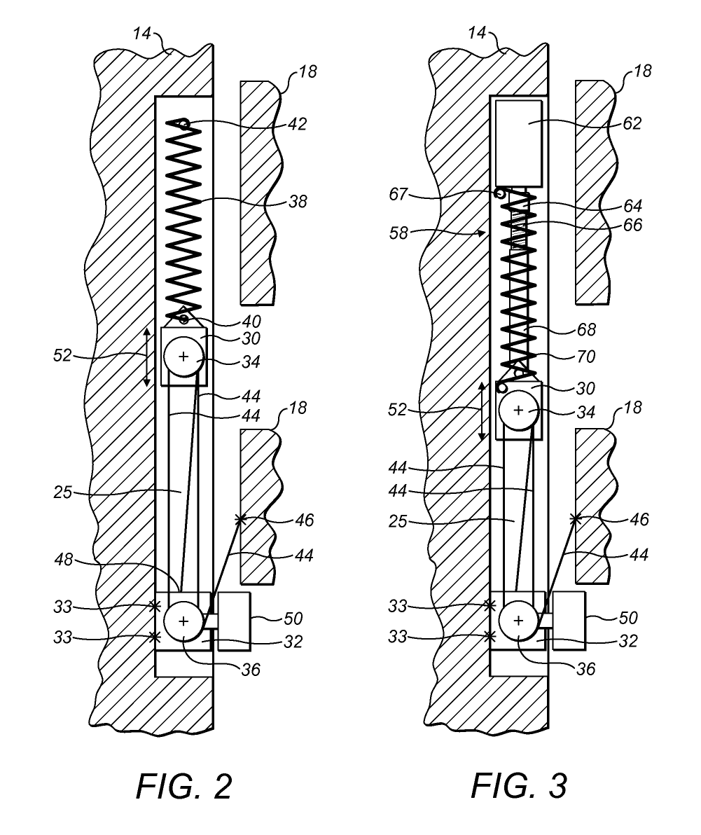

FIG. 2 is a cut-away view of a portion of the sash window of FIG. 1 incorporating a known block and tackle balance mechanism; and

FIG. 3 is a cut-away view of a portion of a sash window incorporating an embodiment of the present invention.

FIG. 1 illustrates a sash window 10 having a frame 12 and upper and lower sashes 14, 16 mounted in the frame 12. The frame 12 includes vertical stiles 18 and 20, a cross-member 22 at the top and a sill 24 at the bottom.

Each of the sashes 14, 16 is mounted in vertical grooves (only one of which 26 is visible in FIG. 1) and may move vertically up and down by sliding in these grooves.

FIG. 2 illustrates a cut-away portion of the sash window of FIG. 1 showing a portion of the stile 18 and upper sash 14.

A block and tackle balance mechanism is mounted in a vertically extending recess or cavity 25 formed in the frame of the sash 14. The block and tackle balance mechanism comprises a tension spring 38 which is attached at its upper end to the sash 14 at a point 42 near the top of the recess 25, and extends downwards within the recess 25. An upper block 30 is attached to the other end of the spring 38 at a point 40, such that it is free to move up and down within the recess 25. A lower block 32 is attached to the sash 14 at points 33 near the bottom of the recess 25. Attached to the respective blocks 30 and 32 are pulleys 34 and 36. A cord 44 is connected to the stile 18 at point 46 at approximately the mid-position of stile 18. The cord 44 extends downwardly towards pulley 36 of the lower block 32, passes around pulley 36, extends upwardly to pulley 34 of the upper block 30, passes around pulley 34, and extends downwardly to return to the lower block 32 to which the end of the cord is attached at point 48.

A slider 50 is attached to the lower block 32 and extends out of the recess 25 so as to co-operate with the groove 26 of stile 18 (see FIG. 1).

The balance mechanism is configured such that, when the sash 14 is in the raised position illustrated in FIG. 2, the tension T in the spring is equal to substantially half the weight of the sash. Accordingly, the spring 38 will, in combination with the spring of a corresponding block and tackle balance mechanism provided at the other side of the window (not shown), act to counterbalance the weight of the sash, and thereby hold the sash in the raised position.

When the sash 14 is drawn downwards by a user to open the sash window 10, the vertical distance between the point 46 and the fixed lower block 32 increases, causing the cord 44 to be pulled out from the pulley system 34, 36. This draws the upper block 34 downwards towards the lower block 32, which in turn causes the spring 38 to extend, to thereby increase the potential energy stored in the spring.

Although the tension in the spring increases as the spring extends, the system is configured such that the maximum increase in tension ΔT (at the fully lowered position) is sufficiently small when compared with the initial tension T (at the fully raised position), that the tension in the spring may be regarded as substantially constant over the full range of movement of the sash. This is achieved by selecting a spring having a sufficiently low force constant k, and by limiting the length over which it is necessary to extend the spring.

With a two-pulley block and tackle, the maximum displacement of the upper block 30, and thus the maximum extension required of the spring, will be equal to half the distance traveled by the sash between its raised and lowered positions. It will be appreciated that the extension required of the spring can be further reduced by introducing additional pulleys into the block and tackle arrangement.

Since the tension in the spring 38 is substantially constant over the full range of movement of the sash, the upward force exerted by the spring on the sash remains equal to substantially half the weight of the sash as the sash is lowered. Accordingly, the spring will, in combination with its counterpart at the other side of the sash, continue to counterbalance the weight of the sash as the sash is lowered. This means that the user is not required to support the weight of the sash, and that when the user releases the sash at the desired position, the sash will remain at that position.

When the sash 14 is subsequently raised by the user to close the window, the vertical distance between the point 46 and the fixed lower block 32 decreases, which allows the cord 44 to be drawn back into the pulley system 34, 36 as the spring 38 contracts, pulling the upper block 34 upwards away from the lower block 32.

Again, as the tension in the spring is substantially constant over the full range of movement of the sash, the spring will, in combination with its counterpart at the other side of the sash, counterbalance the weight of the sash throughout the upward movement, such that the user is not required to bear the weight of the sash, and such that when the user releases the sash at the desired position, it will remain in that position.

It will be appreciated that the energy required to lower the sash against the tension in the springs is obtained from the release of gravitational potential energy as the sash is lowered, whilst the energy required to raise the sash against the force due to gravity (the weight of the sash) is obtained from the release of the potential energy stored in the springs as they contract.

Thus, the only work required of the user when raising or lowering the sash, is that required to overcome friction in the system, ie, between the slider 50 and the groove 25, between the edge of the sash and the mating face of the stile, and between the cord 44 and the pulleys 34, 36. Accordingly, the user is not required to bear the weight of the sash when raising or lowering the sash.

Moreover, in the absence of any external forces being applied by a user, the upward force exerted on the sash by each spring will be substantially equal to the downward force exerted on each spring by the sash under gravity, i.e., half the weight of the sash. Accordingly, any resultant force will be negligibly small, and insufficient to overcome friction in the system, such that the sash will remain stationary. Thus, once the sash is released by the user at any position between its fully raised and fully lowered positions, it will remain stationary with its weight counterbalanced by the springs.

The present invention draws on the principles of the manual block and tackle balance mechanism described above to achieve a powered system for raising or lowering the sashes of a sash window, and thereby enables the opening and closing of such windows to be automated. At the same time, the requirement for bulky, expensive and high power consuming equipment seen with previously known motorised systems is avoided.

FIG. 3 illustrates a cut-away portion of a sash window incorporating a powered block and tackle balance which embodies the present invention, and which may be used with the sash window of FIG. 1 in place of the manual block and tackle balance of FIG. 2. Features common to the block and tackle balance of FIG. 2 and the present embodiment are given common reference numerals.

The powered system comprises a tension spring 70 connected to a block and tackle mechanism housed in a recess in the frame of a sash window 14. The block and tackle mechanism comprises an upper block 30 and a lower block 32, each having a respective pulley 34, 36 attached thereto, and a cord 44 which passes around the pulleys and attaches at one end to the sash 14, and at the other end to the stile 18 of the window. These elements are described in more detail in relation to the manual block and tackle system of FIG. 2, which description also applies here.

The powered block and tackle system further comprises a driving mechanism 58, which includes an electric motor (gearmotor) 62, a controller (not shown) a drive collar 64, a drive shaft 66 and a drive tube 68.

The electric motor 62 is housed within the recess 25 at the upper end thereof. The controller (not shown) allows a user to control the operation of the motor. The motor is connected to the drive shaft 66 by a drive collar 64. The drive shaft extends vertically downwards from the motor, and is slightly longer than the required vertical displacement of the upper block 30 with respect to the lower block 32. The drive shaft is formed with an external thread along substantially its entire length.

The drive tube 68 comprises a nut or other internally threaded portion formed at an upper end thereof, for engagement with the externally threaded surface of the drive shaft 66. The drive tube is attached at a lower end thereof to the upper block 30. The recess 25 and the block 30 each have a substantially square cross section, whilst the cross-sectional area of the block is slightly smaller than that of the recess. Accordingly, the block 30 can slide freely within the recess, but cannot rotate relative to the recess. The drive tube 68 is thus prevented from rotating relative to the recess through its attachment to the block 30. Accordingly, when the drive shaft 66 is rotated, the drive tube 68 is caused to move up and down along the length of the drive shaft 66, thereby raising and lowering the block 30.

The length of the drive tube 68 is approximately equal to the distance from the top of the threaded section of the drive shaft to the top of the upper block 30 when located at its highest position within the recess 25, which corresponds to the fully closed (raised) position of the sash 14. Accordingly, when the drive tube is located at its uppermost position on the drive shaft 66, the upper block 30 will be located at its highest position within the recess 25, and the sash 14 will be located at its fully open (raised) position.

Further, as mentioned above, the drive shaft 66 is slightly longer than the required vertical displacement of the upper block 30 with respect to the lower block 32, ie, the displacement required when the sash moves from its fully closed (raised) position to its fully closed (lowered) position, and is threaded along substantially its entire length. Accordingly, when the drive tube 68 is located at its lowest position on the drive shaft, the upper block 30 will be located at its lowest position within the recess 25, and the sash 14 will be located at its fully closed (lowered) position.

The drive shaft 66, the drive tube 68 and the tension spring 70 are arranged to extend substantially coaxially within the recess 25, such that the drive shaft and the drive tube are located radially within the turns of the tension spring.

To allow room for the provision of the motor 62, the tension spring 70 is attached to the sash at a point 67 below the motor. This point is somewhat lower than the corresponding attachment point 46 of the manual system of FIG. 2, such that the spring of the spiral balance system must be shorter in length than the equivalent spring of the manual balance system. This change may be compensated for by selecting a spring having a suitable length and force constant and by configuring the block and tackle mechanism to achieve the tension of the required magnitude, and having the required uniformity, to counterbalance its share of the weight of the sash 14 over the full range of movement thereof.

The operation of the powering means 58 will now be described with reference to FIG. 3. The motor 62 rotates the drive collar 64 and the drive shaft 66. As discussed above, the drive tube 68 is connected to the upper block 30 which prevents rotation of the drive tube 66. Due to the engagement between the thread of the drive shaft 66 and the thread of the drive tube 68, rotation of the shaft 66 causes the tube 68 to move up or down, depending on the direction of rotation of the motor 62, along the length of the tube (i.e., in the directions indicated by arrow 52), thereby opening or closing the sash 14.

To lower the upper sash 14, (i.e. to open the window), the motor 62 rotates the drive collar 64 and thereby drives shaft 66 in the appropriate direction to cause the tube 68 and the upper block 30 to move down, thereby extending the spring. As the upper block 30 moves towards the lower block 32, the excess cord passes out from the lower pulley 36, increasing the length of cord 44 in the section between the lower pulley 36 and the attachment point 46 on the stile 18, such that the sash is caused to move downwards within the window frame.

To raise the sash (i.e. to close the window), the motor 62 rotates the drive collar 64 and drive shaft 66 in the appropriate direction to cause the tube 68 and the upper block 30 to move up, thereby contracting the spring 70. As the upper block 30 moves away from the lower block 32, the cord 44 is drawn back over the lower pulley 36, thereby decreasing the distance the length of cord 44 in the section between the lower pulley 36 and the attachment point 46 on the stile 18, such that the sash is caused to move upwards within the window frame.

Thus, the position of the sash within the window frame is associated via the cord with the position of the upper block within the frame of the sash, ie, with respect to the lower block.

As with the manual spiral balance, the properties of the spring 70 and the block and tackle mechanism are selected such that the tension T in the spring is substantially constant over the full range of movement of the sash, and is equal to substantially half the weight of the sash. Accordingly, at any point in the movement of the sash, the weight of the sash will be counterbalanced by the tension in the spring 70 and the spring of a corresponding mechanism provided at the other side of the sash.

Thus, when the motor switched off, the upward force exerted on the sash by each spring will be substantially equal to the downward force exerted on each spring by the sash under gravity (ie, half the weight of the sash). Accordingly, any resultant force will be negligibly small, and insufficient to overcome friction in the system, such that the sash will remain stationary. This is the case irrespective of the position of the sash within the window frame. Accordingly, the sash will remain in whatever position it is in when the motor is switched off.

Moreover, the only work required of the motor when raising or lowering the sash, is that required to overcome friction in the system, ie, between the slider 50 and the groove 25, between the edge of the sash and the mating face of the stile, and between the cord 44 and the pulleys 34, 36. Thus, the motor is not required to bear the weight of the sash, so that a smaller motor is needed as compared to prior art systems in which the entire weight of the sash has to be lifted by the motor.

The operation of the lower sash 16 is similar to that of the upper sash 14 as described above, except that the window is closed when the sash 16 is at its fully lowered position, and open when the sash 16 is at fully raised position.

The apparatus also includes an optional detector (not shown), which is connected to the controller and is able to detect the position of the sash 14 relative to the window frame 12, and when movement of the sash 14 is obstructed. This allows the controller to stop operation of the motor 62, and thus prevent further movement of the sash 14, when the window is in the closed position, or when there is an obstruction in the way of the sash 14.

A battery (not shown) is provided within a cavity in the sash frame for providing power to the driving means.

Moreover, by providing a driving mechanism that can be housed entirely within the frame of the sash, the need for potentially bulky and unaesthetic external housing for components of the mechanism is avoided.

To fit a driving mechanism 58 to an existing sash window, the following steps are taken, with reference to FIG. 3. Firstly, the original spring 38 must be removed from the recess 25. An electric motor 62 is then attached in the recess 25 formed in the sash 14. The motor 62 has a drive collar 64, which the motor causes to rotate. The rotational axis of the drive collar is aligned with the recess 25 of the sash 14.

A threaded drive shaft 66 is attached to the motor by means of the drive collar 64. An internally threaded drive tube 68 is screwed onto the drive shaft 66. A replacement tension spring 70, having suitable properties for counterbalancing the weight of the sash over its full range of movement, as described in more detail above, is then placed coaxially around the drive shaft 66 and drive tube 68. The spring 70 is then attached to the sash 14 at the point 67. Next, the tube 68 is connected to the block 30, which may be adapted for the purpose of attaching to the tube 68. The motor 62 is connected to a controller (not illustrated).

In the same manner, a second power mechanism may also be attached to the sash 14 and the motor of this second mechanism connected to the same control. Controls of this type are known and ensure that the two motors operate in unison to open or close the sash. As the sash window comprises two sashes, four of such powering means could be provided for each window.

Alternatively, the or each sash may be provided with a powered block and tackle balance means embodying the present invention on one side, and a standard unpowered block and tackle means on the other side.

The apparatus of the present invention may be applied to either or both sides of a sash window. Where the apparatus of the present invention is provided at only one side of a window, an unpowered balance mechanism may be provided at the other side of the sash for counterbalancing the (or a share of) the weight of the sash. In this case, it is necessary for the driving mechanism to be capable of overcoming the effects of friction at both sides of the sash.

It will be appreciated that with the present invention, the weight of the sash need not be fully counterbalanced by the spring 70, and that the spring 70 could be omitted. In such cases the motor would need to be capable of bearing some or all of the weight of the sash on the upward movement.

A particular advantage of the present invention is that the provision of the driving mechanism 58 requires only relatively minor modification of the manual block and tackle balance system. Accordingly, it is straightforward to adapt the manufacturing processes involved in producing sash windows with manual block and tackle balance mechanisms, to provide the powered mechanism of the present invention. In particular, since the drive shaft 66 and the drive tube 68 are provided concentrically with the spring 70, this part of the driving mechanism occupies space which is not used in manual block and tackle systems. This, in combination with the small size of the motor, means that the driving mechanism can be located within the dimensions of the recess required by the manual block and tackle mechanism. This avoids the need for the frame of the sash to be redesigned to accommodate the driving mechanism. Accordingly, the present invention can be readily applied to existing standard designs.

In the above description of the present invention, the driving member which drives the sash window is a tube, and the rotational member rotated by the motor is a drive shaft. However, the driving member may be formed as a shaft, with a threaded section at or adjacent the end thereof. In this case, the rotational member will be an internally threaded tube. Further, although the drive shaft 66 and drive tube 68 are arranged coaxially with the tension spring 38 in the embodiment described above, they could be placed adjacent and substantially parallel to the tension spring 38 without affecting the driving mechanism.

Furthermore, as an alternative construction to the use of a nut at one end of the drive tube, a 25 to 30 mm section of the end of the tube could be deformed to have a triangular cross-section, with an internal thread being cut therein. Also, the cord 44 could be attached at one end to the upper block 30, depending on the mechanical ratios required by a particular window system.

In the above description, power is supplied to the motor by a battery. Power supply terminals may be provided at a suitable position in the groove 26 of the stile 18 of the sash window, for connection with corresponding terminals on the battery when the sash is located in, for example, its closed position. Alternatively, the motor may be powered via a sliding connection with power supply terminals located along the length of the groove 26, or via a wired connection to an external power supply.

The detector, controller, battery and/or power supply electronics may be housed in the sash. A separate cavity may be provided for housing the or each of these elements.

The present invention has been described in terms of a simple block and tackle balance mechanism. However, it will be appreciated that the present invention may equally be applied to more complex block and tackle mechanisms. For example more than one pulley may be provided on each block.

The present invention has been described in terms of apparatus for raising and lowering a sash window. It will be appreciate that such apparatus would also be suitable for raising and lowering other loads such as, for example, door panels.

1. Apparatus for raising and lowering a sash relative to the frame of a sash window, the apparatus comprising:—
at least one first pulley for fixed attachment to the sash;
at least one second pulley for moveable engagement with the sash;
a cord which passes around and away from the first and second pulleys for attachment to a fixed point on the window frame, for operably linking the position of the sash relative to the window frame to the position of the second pulley(s) relative to the sash; and
driving means for moving the second pulley(s) relative to the sash, to thereby raise and lower the sash relative to the window frame.

2. Apparatus according to claim 1 further comprising spring means for exerting an upward force on the second pulley, to counterbalance at least a share of the weight of the sash.

3. Apparatus according to claim 1 wherein the spring means comprises a tension spring attached at one end to the sash and at the other end to the second pulley.

4. Apparatus according to claim 1 comprising a plurality of first pulleys and/or a plurality of second pulleys.

5. Apparatus according to claim 1 wherein the second pulley(s) may be configured to be linearly moveable relative to the sash, whilst rotational movement of the second pulley(s) relative to the sash is substantially prevented.

6. Apparatus according to claim 1 wherein the driving means comprises a driving member for attachment to the second pulley, and a rotational member for engagement with the driving member, such that rotation of the rotational member causes the driving member to move linearly for moving the second pulley relative to the sash.

7. Apparatus according to claim 6 wherein the rotational member has a threaded surface for engaging a correspondingly threaded surface associated with the driving member for linearly moving the driving member when the rotational member is rotated.

8. Apparatus according to claim 6 further comprising a motor for rotating the rotational member

9. Apparatus according to claim 6 wherein the driving member is an elongate tube.

10. Apparatus according to claim 6 wherein the rotational member is an elongate cylinder.

11. Apparatus according to claim 6 wherein the driving member and/or the rotational member are coaxial with the spring means.

12. Apparatus according to claim 1 further comprising control means for controlling operation of the driving means.

13. Apparatus according to claim 1 further comprising means for detecting the position of the sash relative to the window frame.

14. Apparatus according to claim 1 further comprising means for detecting when movement of the sash is obstructed.

15. A sash window comprising one or more apparatuses as claimed in claim 1.

16. A method of fitting the apparatus of the present invention to a sash window fitted with a block and tackle balance mechanism, the method comprising:—
removing the spring of the block and tackle balance mechanism;
mounting a motor within the space previously occupied by said spring;
connecting a rotational member to the motor;
engaging a driving member with the rotational member;
engaging the driving member with a movable pulley of the block and tackle mechanism.

17. A method according to claim 16, further comprising selecting a new spring, attaching the new spring at one end to the sash at an attachment point below the motor within the recess, and at the other end to an attachment point on the moveable block.
